(19) United States
(12) Patent Application Publication
(10) Pub. No.: US 2021/0344704 A1
(43) Pub. Date: Nov. 4, 2021

(54) Network Defense Method and Security Detection Device

(71) Applicant: Huawei Technologies Co., Ltd., Shenzhen (CN)

(72) Inventor: Zhenwei Zhang, Nanjing (CN)

(21) Appl. No.: 17/244,396

(22) Filed: Apr. 29, 2021

(30) Foreign Application Priority Data
Apr. 30, 2020 (CN) 202010360350.4

(51) Int. Cl. H04L 29/06

(52) U.S. Cl. CPC H04L 63/1433; H04L 63/0245; H04L 63/145; H04L 63/1416

(57) ABSTRACT

A network defense method and a security detection device, to resolve a problem of malicious traffic spreading in a campus network. The method includes a security detection device receiving a first packet. The security detection device detects the first packet when security detection on the first packet is not completed and a security detection capability of the security detection device is sufficient to detect the first packet. Furthermore, the security detection device forwards the first packet when security detection on the first packet is not completed and the security detection capability of the security detection device is insufficient.

### CROSS-REFERENCE TO RELATED APPLICATION

This application claims priority to Chinese Patent Application No. 202010360350.4 filed on Apr. 30, 2020, which is hereby incorporated by reference in its entirety.

### TECHNICAL FIELD

This application relates to the field of communications technologies, and in particular, to a network defense method and a security detection device.

### BACKGROUND

With development of information and communications technology (ICT), network attack events proliferate. A campus network, for example, an intranet of an enterprise, needs to defend against a network attack from an external network and a network attack launched from the campus network.

A detection point is usually deployed on a user access side of the campus network, to defend against malicious traffic that threatens network security. However, depending only on the detection point on the access side, the campus network has a weak defense performance. The malicious traffic cannot be effectively blocked from accessing the campus network. As a result, the malicious traffic is spread on the campus network and security of the campus network is threatened.

### SUMMARY

Embodiments of this application provide a network defense method and a security detection device, to resolve a problem of malicious traffic spreading on a campus network.

According to a first aspect, embodiments of this application provide a network defense method including the following.

A security detection device receives a first packet.

The security detection device detects the first packet when security detection on the first packet is not completed and a security detection capability of the security detection device is sufficient to detect the first packet.

Alternatively, the security detection device forwards the first packet when security detection on the first packet is not completed and a security detection capability of the security detection device is insufficient.

In the embodiments of this application, when receiving a packet on which the security detection is not completed, the security detection device determines, based on the security detection capability of the security detection device, to detect the packet or forward the packet to another security detection device for detection. The security detection device may be any network device on a campus network. Security detection capabilities of a plurality of network devices can be used to detect the packet. This effectively prevents malicious traffic from being spread on the campus network and improves security defense performance.

In an optional implementation, the method further includes that the security detection device determines, based on whether the first packet has a detection flag, whether the security detection on the first packet is completed.

In the embodiments of this application, a detection flag is added to a packet on which the security detection is completed. The security detection device can quickly determine, by determining whether a packet has a detection flag, whether the security detection on the packet is completed. This helps improve detection efficiency.

In an optional implementation, the method further includes that the security detection device checks whether a value of a specified field of the first packet is the detection flag. The specified field is associated with a type of the security detection.

In the embodiments of this application, a specified field is configured for a packet to indicate related-type security detection. The security detection device may determine, by checking whether a value of the specified field in the packet is a detection flag, whether the packet passes the related-type security detection indicated by the specified field.

In an optional implementation, the method further includes the following.

Before detecting or forwarding the first packet, if a detection record of a flow to which the first packet belongs indicates that the flow is insecure, the security detection device discards the first packet.

The security detection device updates, based on a detection result of the first packet, the detection record of the flow to which the first packet belongs.

In an optional implementation, when the first packet belongs to a new flow, the method further includes constructing a flow entry of the new flow.

In an optional implementation, that the security detection device detects the first packet when security detection on the first packet is not completed and a security detection capability of the security detection device is sufficient to detect the first packet includes the following.

When first-type security detection is completed but second-type security detection is not completed on the first packet and the security detection capability of the security detection device is sufficient to perform the second-type security detection on the first packet, the security detection device performs the second-type security detection on the first packet.

According to a second aspect, embodiments of this application provide a security detection device, including a receiving module, configured to receive a first packet, and a processing module, configured to detect the first packet when security detection on the first packet is not completed and a security detection capability of the security detection device is sufficient to detect the first packet, or forward the first packet when security detection on the first packet is not completed and a security detection capability of the security detection device is insufficient.

In the embodiments of this application, when receiving a packet on which the security detection is not completed, the security detection device determines, based on the security detection capability of the security detection device, to detect the packet or forward the packet to another security detection device for detection. The security detection device may be any network device on a campus network. Security detection capabilities of a plurality of network devices on the campus network can be used to detect the packet. Compared with the other approaches in which a detection point is deployed only at an access layer, this effectively prevents malicious traffic from being spread on the campus network and improves security defense performance.

In an optional implementation, the processing module is further configured to determine, based on whether the first packet has a detection flag, whether the security detection on the first packet is completed.

In an optional implementation, the processing module is further configured to check whether a value of a specified field of the first packet is the detection flag. The specified field is associated with a type of the security detection.

In the embodiments of this application, a specified field is configured for a packet to indicate related-type security detection. The security detection device may determine, by checking whether a value of the specified field in the packet is a detection flag, whether the packet passes the related-type security detection indicated by the specified field.

In an optional implementation, the processing module is further configured to before detecting or forwarding the first packet, if a detection record of a flow to which the first packet belongs indicates that the flow is insecure, discard the first packet, and update, based on a detection result of the first packet, the detection record of the flow to which the first packet belongs.

In an optional implementation, the processing module is further configured to when first-type security detection is completed but second-type security detection is not completed on the first packet and the security detection capability of the security detection device is sufficient to perform the second-type security detection on the first packet, perform the second-type security detection on the first packet.

In the embodiments of this application, the security detection device performs, based on the security detection capability of the security detection device, security detection that can be performed on a packet. Security detection capabilities of different security detection devices on the campus network can be used to perform one or more types of security detection on the packet.

According to a third aspect, embodiments of this application provide a communications apparatus, including a processor and a memory.

The memory is configured to store a computer program. The processor is configured to execute the computer program stored in the memory, so that the method in any possible implementation of the first aspect is performed.

According to a fourth aspect, embodiments of this application provide a communications apparatus, including a processor and an interface circuit. The interface circuit is configured to receive a code instruction and transmit the code instruction to the processor. The processor is configured to run the code instruction to perform the method in any possible implementation of the first aspect.

According to a fifth aspect, embodiments of this application provide a computer-readable storage medium. The computer-readable storage medium stores an instruction, and when the instruction is executed, the method in any possible implementation of the first aspect is implemented.

According to a sixth aspect, embodiments of this application provide a computer program product. The computer program product includes computer program code. When the computer program code is executed by a processor of a communications apparatus, the communications apparatus is enabled to perform the method in any possible implementation of the first aspect.

### BRIEF DESCRIPTION OF DRAWINGS

FIG. 1 is a schematic diagram of a network architecture according to an embodiment of this application;

FIG. 2 is a schematic structural diagram of a communications system according to an embodiment of this application;

FIG. 3 is a schematic flowchart of a network defense method according to an embodiment of this application;

FIG. 4 is a schematic flowchart of another network defense method according to an embodiment of this application;

FIG. 5 is a schematic structural diagram of a security detection device according to an embodiment of this application;

FIG. 6 is a schematic structural diagram of another security detection device according to an embodiment of this application;

FIG. 7 is a schematic structural diagram of a communications apparatus according to an embodiment of this application; and

FIG. 8 is a schematic structural diagram of another communications apparatus according to an embodiment of this application.

### DESCRIPTION OF EMBODIMENTS

In the following, some terms in this application are described, to help a person skilled in the art have a better understanding.

(1) Campus Network:

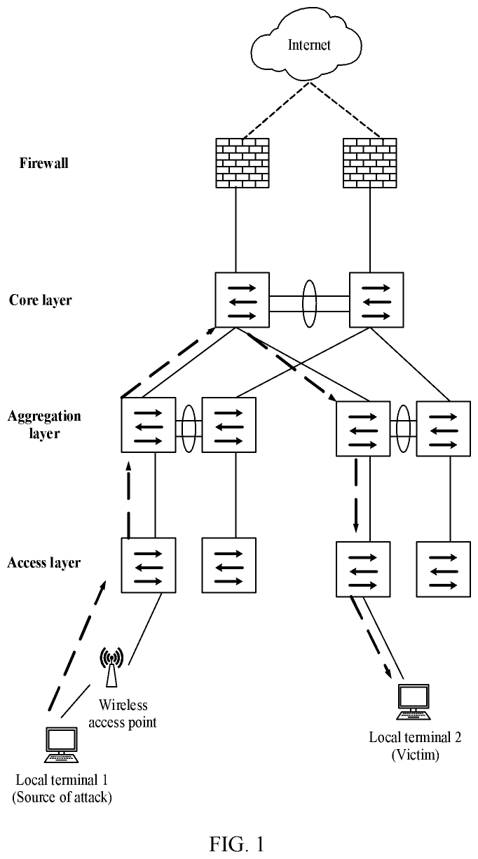

A campus network refers to an internal network of an organization, for example, an intranet of an enterprise or a school virtual private network (VPN) of a university. A routing structure of the campus network is managed by an organization. Security products, such as a firewall, are usually deployed at an internet egress of the campus network to defend against an attack from an external network. As shown in a network architecture in FIG. 1, the campus network usually uses a three-layer network architecture, including an access layer, an aggregation layer, and a core layer. The access layer provides access from a local terminal to the campus network for a network application. The aggregation layer is a boundary between the core layer and the access layer. The core layer is used to provide intersection transmission for receiving and forwarding network traffic.

(2) Network Traffic:

In embodiments of this application, network traffic refers to a volume of data transmitted in a campus network, and includes packets of a plurality of flows. Network traffic that threatens campus network security is referred to as malicious traffic. For example, a network attack between local terminals that access the campus network causes transmission of the malicious traffic on the campus network. In the embodiments of this application, a forwarding path of the malicious traffic on the campus network is further shown by using a dashed line with an arrow in FIG. 1. The malicious traffic is transmitted to the campus network by a local terminal 1 that is used as a source of attack, and then, the malicious traffic is transmitted from a network device at an access layer→(signifying a “to”) a network at an aggregation layer→a network device at a core layer→a network device at the aggregation layer→a network device at the access layer. Finally, the malicious traffic is transmitted to a local terminal 2 that is attacked. The local terminal may access the campus network in a wireless connection manner by using a wireless access point (AP), or may access the campus network in a wired connection manner.

(3) In this application, “a plurality of” refers to two or more than two. The term “and/or” describes an association relationship for describing associated objects and represents that three relationships may exist. For example, A and/or B may represent the following three cases: only A exists, both A and B exist, and only B exists. In addition, it should be understood that although terms such as “first” and “second” may be used in the embodiments of the present disclosure to describe data, the data is not limited to these terms. These terms are merely used to distinguish the data from each other.

The method provided in the embodiments of this application may be applied to a communications system on the campus network. The communications system includes network devices deployed at the access layer, the aggregation layer, and the core layer of the campus network. For network traffic accessing the campus network, security detection is performed on the network traffic based on a security detection capability of a network device through which a forwarding path of the network traffic passes.

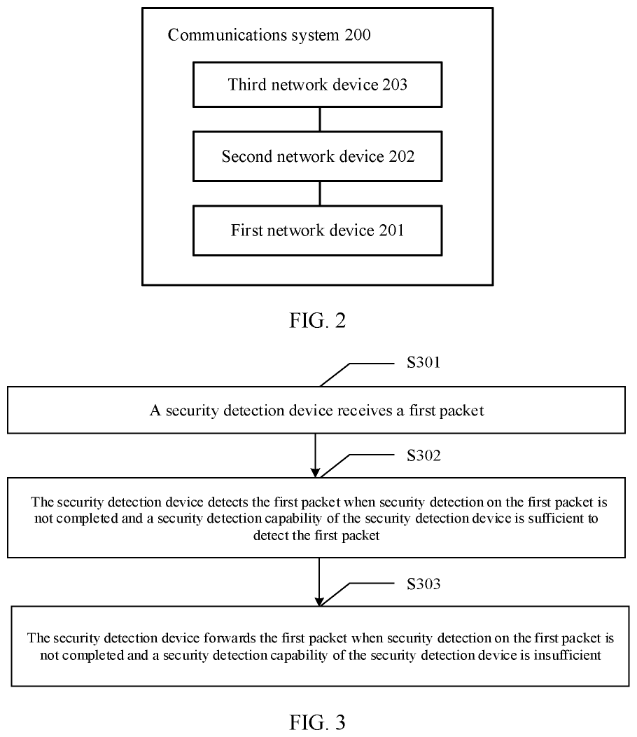

FIG. 2 shows an example of a communications system 200 to which a method according to an embodiment of this application is applicable. The communications system 200 includes a first network device 201 deployed at an access layer, a second network device 202 deployed at an aggregation layer, and a third network device 203 deployed at a core layer.

The first network device 201 is configured to perform security detection on a packet in network traffic that accesses a campus network by using the first network device.

The second network device 202 is configured to perform, based on a security detection capability of the second network device 202, security detection or forwarding on a packet that is transmitted at the access layer or the core layer and on which the security detection is not completed.

The third network device 203 is configured to perform, based on a security detection capability of the third network device 203, security detection or forwarding on a packet that is transmitted at the aggregation layer and on which the security detection is not completed.

In this embodiment of this application, network devices at different layers on the campus network are used as security detection devices to perform the security detection on network traffic by using expansion of a network traffic forwarding path, so that a security defense capability of the campus network may be improved.

The following describes some optional implementations of the embodiment in FIG. 3.

Referring to FIG. 3, an embodiment of this application provides a network defense method. The method may be applied to any network device used as a security detection device in a campus network, and a network device having a security detection capability is referred to as the security detection device below. The method may be implemented by performing the following steps:

Step 301: The security detection device receives a first packet.

Step 302: The security detection device detects the first packet when security detection on the first packet is not completed and a security detection capability of the security detection device is sufficient to detect the first packet.

Step 303: The security detection device forwards the first packet when security detection on the first packet is not completed and a security detection capability of the security detection device is insufficient.

In the embodiment of this application, when receiving a packet on which the security detection is not completed, the security detection device determines, based on the security detection capability of the security detection device, to detect the packet or forward the packet to another security detection device for detection. The security detection device may be any network device on the campus network. Security detection capabilities of a plurality of network devices on the campus network can be used to perform security detection on the packet. Compared with the other approaches in which a detection point is deployed only at an access layer, this effectively prevents malicious traffic from being spread on the campus network and improves security defense performance.

In an optional implementation, a detection flag may be added to a packet to indicate that the security detection on the packet is completed. Therefore, the security detection device may determine, based on whether the first packet has a detection flag, whether the security detection on the first packet is completed. The detection flag indicates whether a detection result of the packet is secure or insecure.

In the embodiment of this application, a detection flag is added to a packet on which the security detection is completed. The security detection device can quickly determine, by determining whether a packet has a detection flag, whether the security detection on the packet is completed. This helps improve detection efficiency.

In an optional implementation, a detection flag may be added to a specified field in the packet on which the security detection is completed. The security detection device may determine, by checking whether a value of a specified field of the first packet is the detection flag, whether the security detection on the first packet is completed.

The specified field is used to indicate security detection corresponding to the packet, and may also be referred to as a detection flag bit. A byte occupied by the specified field in the packet may be fixedly configured, or may be configured through joint negotiation by security detection devices on the campus network. This is not limited herein. For example, in a virtual extensible local area network (VXLAN), an 8-bit reserved bit in a VXLAN packet header shown in Table 1 may be used to indicate the security detection corresponding to the packet. In a conventional local area network, the last two bits in a type of service (ToS) field of an Internet Protocol (IP) version 4 (IPv4) packet header shown in Table 2, namely, a reserved bit, may be used to indicate the security detection corresponding to the packet.

TABLE 1

| | | | |
|---|---|---|---|
| VXLAN Flags | Group ID | VNI | Reserved |
| (16 bits) | (16 bits) | (24 bits) | (8 bits) |

The VXLAN flags are VXLAN flag bits and occupy 16 bits in the VXLAN packet header. The group ID is a group identity (ID) and occupies 16 bits in the VXLAN packet header. A VXLAN network identifier (VNI) occupies 24 bits in the VXLAN packet header. The reserved is a reserved bit and occupies 8 bits in the VXLAN packet header.

TABLE 2

| | |
|---|---|
| DSCP | Reserved |
| (6 bits) | (2 bits) |

The DSCP is a differentiated services code point and occupies the first 6 bits in a ToS field of an IPv4 packet header. The reserved is a reserved bit and occupies the last 2 bits in the ToS field of the IPv4 packet header.

In an optional implementation, the security detection on a packet includes one or more types of security detection. One or more specified fields may be configured for the packet, and the specified field is associated with a type of the security detection. For example, one specified field corresponds to one type of the security detection. The security detection device may determine, by checking whether a value of any specified field in one or more specified fields of the first packet is a detection flag, whether multiple related types of security detection of the any specified field are completed on the first packet.

During specific implementation, a byte occupied by the any field may be set based on an actual situation, and is not limited herein. For example, a byte occupied by any field includes 1 bit. Table 3 shows that two bits obtained by dividing the 8-bit reserved bit in the VXLAN packet header are configured as a first specified field associated with an intrusion prevention system (IPS), namely, an IPS flag in Table 3, and a second specified field associated with antivirus (AV) detection, namely, an AV flag in Table 3.

TABLE 3

| | | |
|---|---|---|
| IPS Flag | AV Flag | Reserved |
| (1 bit) | (1 bit) | (6 bits) |

For example, when the byte occupied by any specified field includes 1 bit, and a value of a detection flag is 0 or 1, if a value of any specified field is not the detection flag, for example, the value of any specified field is null, it indicates that the related-type security detection of the any specified field is not completed on the first packet. Alternatively, if a value of any specified field is 0, it indicates that related-type security detection of the any specified field is completed on the first packet, and a detection result is that the any specified field is insecure. Alternatively, if a value of any specified field is 1, it indicates that related-type security detection of the any specified field is completed on the first packet, and a detection result is that the any specified field is secure.

In this embodiment of this application, a specified field is configured for a packet to indicate related-type security detection. The security detection device may quickly determine, by checking whether a value of the specified field in the packet is a detection flag, whether the related-type security detection indicated by the specified field is completed on the packet.

In an optional implementation, the security detection on the first packet includes one or more types of security detection. If at least one of the one or more types of security detection is not completed on the first packet, the security detection device determines that the security detection on the first packet is not completed. Further, when at least one of the one or more specified fields of the first packet is not the detection flag, the security detection device determines that the security detection on the first packet is not completed.

In an optional implementation, the security detection device may determine, based on security detection load of the security detection device and/or a security detection type that can be detected by the security detection device, whether the security detection capability of the security detection device is sufficient to detect the first packet.

During specific implementation, if the security detection load of the security detection device is overloaded, it is determined that the security detection capability of the security detection device is insufficient to detect the first packet. Alternatively, if a type of the security detection that is not completed on the first packet does not belong to the type that can be detected by the security detection device, it is determined that the security detection capability of the security detection device is insufficient to detect the first packet. If the security detection load of the security detection device is not overloaded and the security detection device can perform at least one type of the security detection that is not completed by the security detection device on the first packet, it is determined that the security detection capability of the security detection device is sufficient to detect the first packet.

In an optional implementation, when determining that the security detection on the first packet is not completed, the security detection device may first determine whether the security detection device stores a detection record of a flow to which the first packet belongs. If the security detection device stores the detection record of the flow to which the first packet belongs, the security detection device adds the detection flag to the first packet based on the detection record of the flow to which the first packet belongs. Otherwise, the security detection device needs to determine whether the security detection capability of the security detection device is sufficient to detect the first packet again.

During specific implementation, a detection flow table may be set on the security detection device, to store identification information and a detection record of a flow to which a packet detected by the security detection device belongs. The identification information of the flow may be represented by using 5-tuple information, and the 5-tuple information includes a source IP address, a source port, a destination IP address, a destination port, and a transport layer protocol. The detection record of the flow includes a detection result of the packet belonging to the flow. For determining whether the security detection device stores the detection record of the flow to which the first packet belongs, refer to the following implementation: determining, based on identification information of the flow to which the first packet belongs, whether the first packet matches a detection flow table in the security detection device to which the first packet belongs. In other words, it is determined whether the identification information of the flow to which the first packet belongs matches identification information stored in the detection flow table in the security detection device to which the first packet belongs.

In an optional implementation, when the first packet does not match the detection flow table of the security detection device, in other words, when the first packet belongs to a new flow, the security detection device creates a detection flow table corresponding to the new flow.

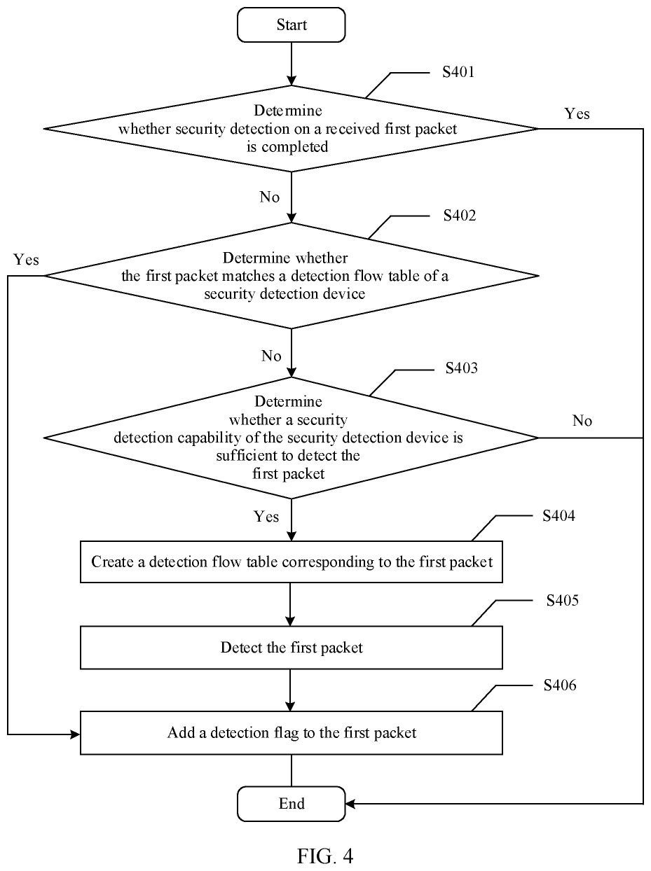

Further, as shown in FIG. 4, an embodiment of this application provides another network defense method. The method is performed by a security detection device, and includes the following steps.

Step S401: Determine whether security detection on a received first packet is completed. If the security detection on the received first packet is not completed, step S402 is performed. If the security detection on the received first packet is completed, no further action is required.

Step S402: Determine whether the first packet matches a detection flow table of the security detection device. If the first packet does not match the detection flow table of the security detection device, step S403 is performed. If the first packet matches the detection flow table of the security detection device, step S406 is performed.

Step S403: Determine whether a security detection capability of the security detection device is sufficient to detect the first packet. If the security detection capability of the security detection device is sufficient to detect the first packet, step S404 is performed. If the security detection capability of the security detection device is not sufficient to detect the first packet, no further action is required.

Step S404: Create a detection flow table corresponding to the first packet.

Step S405: Detect the first packet.

Step S406: Add a detection flag to the first packet.

During specific implementation, if the first packet matches the detection flow table of the security detection device, a detection result of the first packet is determined based on a detection record stored in the detection flow table, and then the detection flag is added to the first packet based on the detection result. If the first packet does not match the detection flow table of the security detection device, step 405 is performed. To be specific, after the first packet is detected and the detection result is determined, the detection flag is added to the first packet based on the detection result.

In an optional implementation, the security detection device updates, based on the detection result of the first packet, a detection record of a flow to which the first packet belongs.

In an optional implementation, that the security detection device detects the first packet when security detection on the first packet is not completed and a security detection capability of the security detection device is sufficient to detect the first packet includes the following.

When first-type security detection is completed but second-type security detection is not completed on the first packet and the security detection capability of the security detection device is sufficient to perform the second-type security detection on the first packet, the security detection device performs the second-type security detection on the first packet.

In this embodiment of this application, the security detection device performs, based on the security detection capability of the security detection device, security detection that can be performed on a packet. Security detection capabilities of different security detection devices on a campus network can be used to perform one or more types of security detection on the packet.

Further, after the security detection device performs the second-type security detection on the first packet, if the security detection capability of the security detection device is sufficient to perform third-type security detection on the first packet, the security detection device performs the third-type security detection on the first packet. Alternatively, after the security detection device performs the second-type security detection on the first packet, if the security detection capability of the security detection device is insufficient to perform third-type security detection on the first packet, the security detection device forwards the first packet.

In an optional implementation, when a detection result of the security detection on the received first packet is insecure, if the first packet is indicated to be discarded, the security detection device discards the first packet. Alternatively, when a detection result of the security detection by the security detection device on the first packet is insecure, if the first packet is indicated to be discarded, the security detection device discards the first packet.

In an optional implementation, before detecting or forwarding the first packet, if the detection record of the flow to which the first packet belongs indicates that the flow is insecure, the security detection device discards the first packet. During specific implementation, if the received first packet matches the detection flow table of the security detection device, and a discard mark is configured for the detection flow table of the flow to which the first packet belongs, the security detection device discards the first packet. The discard mark indicates that the flow is insecure.

In addition, to avoid a case in which security detection on some packets may be missed because there is a small quantity of network devices through which the packets pass on the campus network, in an optional implementation, a network device at a core layer through which network traffic needs to pass when being spread on the campus network may be set. In this case, a forwarding path of the foregoing first packet includes a target network device at the core layer on the campus network.

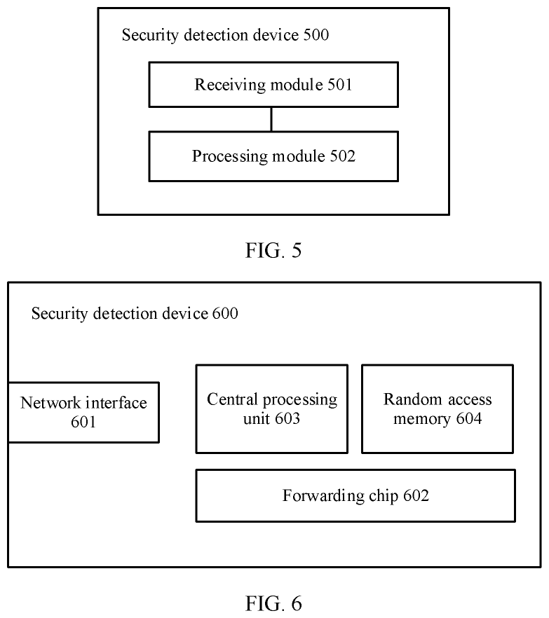

Based on a same concept, referring to FIG. 5, an embodiment of this application provides a security detection device 500, including a receiving module 501, configured to receive a first packet, and a processing module 502, configured to detect the first packet when security detection on the first packet is not completed and a security detection capability of the security detection device is sufficient to detect the first packet, or forward the first packet when security detection on the first packet is not completed and a security detection capability of the security detection device is insufficient.

In the embodiment of this application, when receiving a packet on which the security detection is not completed, the security detection device determines, based on the security detection capability of the security detection device, to detect the packet or forward the packet to another security detection device for detection. The security detection device may be any network device on a campus network. Security detection capabilities of a plurality of network devices on the campus network can be used to detect the packet. Compared with the other approaches in which a detection point is deployed only at an access layer, this effectively prevents malicious traffic from being transmitted on the campus network and improves security defense performance.

In an optional implementation, the processing module 502 is further configured to determine, based on whether the first packet has a detection flag, whether security detection on the first packet is completed. A detection flag is used to indicate a detection result of a packet as secure or insecure.

In an optional implementation, the processing module 502 is further configured to check whether a value of a specified field in the first packet is the detection flag. The specified field is associated with a type of the security detection.

In the embodiment of this application, a specified field is configured for a packet to indicate related-type security detection. The security detection device may determine, by checking whether a value of the specified field in the packet is a detection flag, whether the packet passes the related-type security detection indicated by the specified field.

In an optional implementation, the processing module 502 is further configured to before detecting or forwarding the first packet, determine that a detection record of a flow to which the first packet belongs indicates that the flow is insecure, and discard the first packet, and update, based on a detection result of the first packet, the detection record of the flow to which the first packet belongs.

In an optional implementation, the processing module 502 is further configured to when first-type security detection is completed but second-type security detection is not completed on the first packet and the security detection capability of the security detection device is sufficient to perform the second-type security detection on the first packet, perform the second-type security detection on the first packet.

In this embodiment of this application, the security detection device performs, based on the security detection capability of the security detection device, security detection that can be performed on a packet. Security detection capabilities of different security detection devices on the campus network can be used to perform one or more types of security detection on the packet.

Further, referring to FIG. 6, an embodiment of this application further provides another security detection device 600, including a network interface 601, a forwarding chip 602, a central processing unit (CPU) 603, and a random-access memory (RAM) 604.

The network interface 601 is configured to receive a first packet.

The RAM 604 is configured to store a detection flow table of a flow to which a packet detected by using the security detection device belongs.

The forwarding chip 602 is configured to when the first packet does not have a detection flag, determine whether the first packet matches the detection flow table in the RAM 604.

The central processing unit 603 is configured to, when the first packet does not match the detection flow table in the RAM 604, perform security detection on the first packet based on a security detection capability of the central processing unit 603.

The forwarding chip 602 is further configured to, when the first packet matches the detection flow table in the RAM 604, add the detection flag to the first packet based on a detection record of a flow in the detection flow table, or when the first packet does not match the detection flow table in the RAM 604, add the detection flag to the first packet based on a detection result of the security detection performed by the central processing unit 603 on the first packet.

In this embodiment of this application, the forwarding chip first determines whether the detection flag can be added to the first packet based on the stored detection flow table. When the detection result of the first packet cannot be determined based on the stored detection flow table, the central processing unit performs the security detection on the first packet, so that load of the central processing unit can be reduced, and processing performance of the central processing unit can be effectively improved.

Based on a same concept, FIG. 7 shows a communications apparatus 700 provided in this application. For example, the communications apparatus 700 may be a chip or a chip system. Optionally, in this embodiment of this application, the chip system may include a chip, or may include a chip and another discrete component.

The communications apparatus 700 may include at least one processor 710. The apparatus 700 may further include at least one memory 720, configured to store a computer program, a program instruction, and/or data. The memory 720 is coupled to the processor 710. Coupling in this embodiment of this application may be indirect coupling or a communication connection between apparatuses, units, or modules in an electrical form, a mechanical form, or another form, and is used for information exchange between the apparatuses, the units, or the modules. The processor 710 may cooperate with the memory 720. The processor 710 may execute the computer program stored in the memory 720. Optionally, at least one of the at least one memory 720 may be included in the processor 710.

The communications apparatus 700 may further include a transceiver 730, and the communications apparatus 700 may exchange information with another device by using the transceiver 730. The transceiver 730 may be a circuit, a bus, a transceiver, or any other apparatus that may be configured to exchange information.

In a possible implementation, the communications apparatus 700 may be applied to the foregoing security detection device. Further, the communications apparatus 700 may be the foregoing security detection device, or may be an apparatus that can support the foregoing security detection device in implementing any one of the foregoing embodiments. The memory 720 stores a computer program, a program instruction, and/or data that are/is necessary for implementing a function of the security detection device in any one of the foregoing embodiments. The processor 710 may execute the computer program stored in the memory 720, to complete the method in any one of the foregoing embodiments.

In this embodiment of this application, a specific connection medium among the transceiver 730, the processor 710, and the memory 720 is not limited. In the embodiment of this application, the memory 720, the processor 710, and the transceiver 730 are connected to each other through a bus in FIG. 7. The bus is represented by using a thick line in FIG. 7, and a connection manner between other components is merely described as an example, and is not limited thereto. The bus may be classified into an address bus, a data bus, a control bus, and the like. For ease of representation, only one thick line is used to represent the bus in FIG. 7, but this does not mean that there is only one bus or only one type of bus.

In the embodiment of this application, the processor may be a general-purpose processor, a digital signal processor (DSP), an application-specific integrated circuit (ASIC), a field-programmable gate array (FPGA) or another programmable logic device, a discrete gate or transistor logic device, or a discrete hardware component, and may implement or perform the methods, steps, and logical block diagrams disclosed in the embodiments of this application. The general-purpose processor may be a microprocessor or any conventional processor or the like. The steps of the method disclosed with reference to the embodiments of this application may be directly performed by a hardware processor, or may be performed by using a combination of hardware in the processor and a software module.

In the embodiment of this application, the memory may be a non-volatile memory, for example, a hard disk drive (HDD) or a solid-state drive (SSD), or may be a volatile memory, for example, a RAM. The memory may further be any other medium that can be configured to carry or store expected program code in a form of an instruction or a data structure and that can be accessed by a computer, but is not limited thereto. The memory in the embodiment of this application may alternatively be a circuit or any other apparatus that can implement a storage function, and is configured to store the computer program, the program instruction, and/or the data.

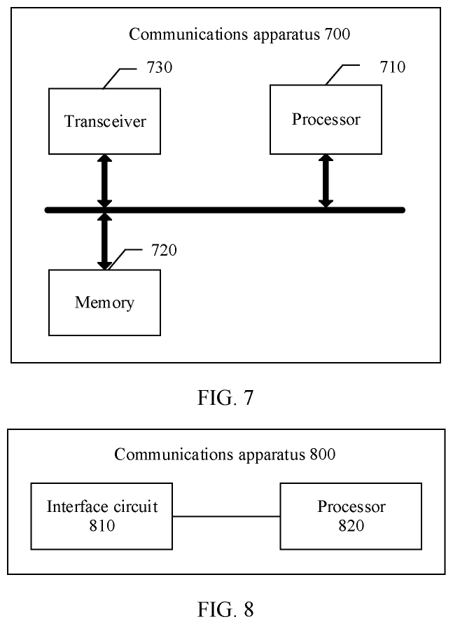

Based on the foregoing embodiments, referring to FIG. 8, an embodiment of this application further provides another communications apparatus 800, including an interface circuit 810 and a processor 820.

The interface circuit 810 is configured to receive a code instruction and transmit the code instruction to the processor 820.

The processor 820 is configured to run the code instruction to perform the method in any one of the foregoing embodiments.

Based on the foregoing embodiments, the embodiment of this application further provides a computer-readable storage medium. The computer-readable storage medium stores an instruction, and when the instruction is executed, the method performed by the security detection device in any one of the foregoing embodiments is implemented. The computer-readable storage medium may include any medium that can store program code, for example, a Universal Serial Bus (USB) flash drive, a removable hard disk, a read-only memory, a RAM, a magnetic disk, or an optical disc.

A person skilled in the art should understand that the embodiment of this application may be provided as a method, a system, or a computer program product. Therefore, this application may use a form of hardware only embodiments, software only embodiments, or embodiments with a combination of software and hardware. Moreover, this application may use a form of a computer program product that is implemented on one or more computer-usable storage media (including but not limited to a disk memory, a compact disc (CD) read-only memory (ROM) (CD-ROM), an optical memory, and the like) that include computer usable program code.

This application is described with reference to the flowcharts and/or block diagrams of the method, the device (system), and the computer program product according to the embodiments of this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a special-purpose computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can indicate the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the other programmable device, thereby generating computer-implemented processing. Therefore, the instructions executed on the computer or the other programmable device provide steps for implementing a specific function in one or more processes in the flowcharts and/or in one or more blocks in the block diagrams.

Obviously, a person skilled in the art can make various modifications and variations to embodiments of this application without departing from the scope of this application. This application is intended to cover these modifications and variations provided that they fall within the scope of protection defined by the following claims and their equivalent technologies.

1. A network defense method implemented by a security detection device, wherein the method comprises:
receiving a packet;
performing security detection on the packet when the security detection on the packet that is received is not completed and a security detection capability of the security detection device is capable of performing the security detection on the packet; and
forwarding the packet when the security detection on the packet that is received is not completed and the security detection capability is not capable of performing the security detection on the packet.

2. The network defense method of claim 1, further comprising determining, based on identifying whether a detection flag is in the packet, whether the security detection on the packet that is received is completed.

3. The network defense method of claim 1, wherein before performing the security detection on the packet that is received, the method further comprises:
discarding the packet when a detection record of a flow to which the packet belongs indicates that the flow is insecure; and
updating, based on a detection result of the packet, the detection record.

4. The network defense method of claim 1, further comprising:
identifying that a first-type security detection is completed on the packet, a second-type security detection is not completed on the packet, and the security detection capability is capable of performing the second-type security detection on the packet; and
performing, in response to the identifying, the second-type security detection on the packet.

5. An apparatus, comprising:
a memory configured to store a computer program; and
a processor coupled to the memory and configured to execute the computer program to cause the apparatus to be configured to:
receive a packet;
perform security detection on the packet when the security detection on the packet that is received is not completed and a security detection capability of the apparatus is capable of performing the security detection on the packet; and
forward the packet when the security detection on the packet that is received is not completed and the security detection capability is not capable of performing the security detection on the packet.

6. A computer program product comprising computer-executable instructions stored on a non-transitory computer-readable storage medium that, when executed by a processor, cause the processor to:
receive a packet;
perform security detection on the packet when the security detection on the packet that is received is not completed and a security detection capability of the apparatus is capable of performing the security detection on the packet, and
forward the packet when the security detection on the packet is not completed and the security detection capability is not capable of performing the security detection on the packet.

7. The computer program product of claim 6, wherein the computer-executable instructions further cause the apparatus to determine, based on whether a detection flag is on the packet, whether the security detection on the packet that is received is completed.

8. The computer program product of claim 6, wherein before detecting the packet, the computer-executable instructions further cause the apparatus to:
discard the packet when a detection record of a flow to which the packet belongs indicates that the flow is insecure; and
update, based on discarding the packet, the detection record.

9. The computer program product of claim 6, wherein the computer-executable instructions further cause the apparatus to:
identify that a first-type security detection is completed on the packet, a second-type security detection is not completed on the packet, and the security detection capability is capable of performing the second-type security detection on the packet; and
perform, in response to the identifying that the first type security detection, the second-type security detection on the packet.

10. The computer program product of claim 9, wherein after performing the second-type security detection on the packet, the computer-executable instructions further cause the processor to:
identify that the security detection capability is capable of performing a third-type security detection on the packet; and
perform, in response to identifying that the security detection capability is capable of performing the third-type security detection on the packet, the third-type security detection on the packet.

11. The computer program product of claim 9, wherein after performing the second-type security detection on the packet, the computer-executable instructions further cause the apparatus to:
identify that the security detection capability is capable of performing a third-type security detection on the packet; and
forward, in response to identifying that the security detection capability is capable of performing the third-type security detection on the packet, the packet.

12. The computer program product of claim 6, wherein before forwarding the packet, the computer-executable instructions further cause the apparatus to:
discard the packet when a detection record of a flow to which the packet belongs indicates that the flow is insecure; and
update, based on discarding the packet, the detection record.

13. The network defense method of claim 4, wherein after performing the second-type security detection on the packet, the method further comprises:
identifying that the security detection capability is capable of performing a third-type security detection on the packet; and
performing, in response to identifying that the security detection capability is capable of performing a third-type security detection on the packet, the third-type security detection on the packet.

14. The network defense method of claim 4, wherein after performing the second-type security detection on the packet, the method further comprises:
identifying that the security detection capability is capable of performing a third-type security detection on the packet; and
forwarding, in response to identifying that the security detection capability is capable of performing the third-type security detection on the packet, the packet.

15. The network defense method of claim 1, wherein before forwarding the packet, the method further comprises:
discarding the packet when a detection record of a flow to which the packet belongs indicates that the flow is insecure; and
updating, based on discarding the packet, the detection record.

16. The apparatus of claim 5, wherein the computer program further causes the apparatus to be configured to determine, based on identifying a detection flag on the packet, whether the security detection on the packet that is received is completed.

17. The apparatus of claim 5, wherein before detecting or forwarding the packet, the computer program further causes the apparatus to be configured to:
discard the packet when a detection record of a flow to which the packet belongs indicates that the flow is insecure; and
update, based on discarding the packet, the detection record.

18. The apparatus of claim 5, wherein the computer program further causes the apparatus to be configured to:
identify that a first-type security detection is completed on the packet and a second-type security detection is not completed on the packet and the security detection capability is capable of performing the second-type security detection on the packet; and
perform, in response to the identifying, the second-type security detection on the packet.

19. The apparatus of claim 18, wherein after performing the second-type security detection on the packet, the computer program further causes the apparatus to be configured to:
identify that the security detection capability is capable of performing a third-type security detection on the packet; and
perform, in response to identifying that the security detection capability is capable of performing the third-type security detection on the packet, the third-type security detection on the packet.

20. The apparatus of claim 18, wherein after performing the second-type security detection on the packet, the computer program further causes the apparatus to be configured to:
identify that the security detection capability is capable of performing a third-type security detection on the packet; and
forward, in response to identifying that the security detection capability is capable of performing the third-type security detection on the packet, the packet.
